(19) United States
(12) Patent Application Publication
(10) Pub. No.: US 2026/0208666 A1
(43) Pub. Date: Jul. 23, 2026

(54) Wireless Taillight Towing Adapter

(71) Applicant: Ernest Everett Owens, JR., Denver, CO (US)

(72) Inventor: Ernest Everett Owens, JR., Denver, CO (US)

(21) Appl. No.: 19/403,765

(22) Filed: Nov. 29, 2025

(51) Int. Cl. B60Q 1/30; H05B 47/19

(52) U.S. Cl. CPC B60Q 1/305; H05B 47/19; B60Q 2900/30

(57) ABSTRACT

A device when attached to an automobiles taillight wiring harness allows the user to transmit taillight signals from an automobile to a towed trailer for taillight signals wirelessly by attaching a miniature radio frequency transmitter to the automobiles taillights and by attaching a miniature radio frequency receiver to the toad trailer for the purpose of transmitting and receiving taillight signals wirelessly

### FIELD

The present application relates to a device that allows the user to attach a miniature wireless radio frequency transmitter to vehicles'taillights and a miniature wireless radio frequency receiver to a towed trailer for the purpose of transmitting taillight signal wirelessly

### BACKGROUND

For the towing industry and the public users of wires to achieve light signals to a towed trailer is and has been for many years and aggravating, cumbersome, and awkward task wires unplugging loss of signal to trailer and rusty wires the electric automobile industry has inadvertently added to the wire towing problem

### SUMMARY

By providing a device that allows taillight signals from a vehicle's taillights to be sent to a towed trailer wirelessly as described by the embodiments will stop various ways of loss of taillight signals to towed trailer no more chords to come unplugged or rusty wires

This disclosed exemplary embodiment provides a device to transmit light signals from an automobile's taillights to a towed trailer for taillights wirelessly further objects features advantages and properties of device according to the present application will become apparent from the detailed description. It should be noted that although only a miniature wireless taillight adapter is described the teachings of this application can be used on trailers with electric brakes although the invention has been understood many other possible modifications and variations can be made without departing from the original spirit and scope of this invention as hereinafter claimed

### DESCRIPTION OF DRAWINGS

In the following detailed portion of the present application will be explained in more detail with reference to the example embodiments shown in the drawing in which

FIG. 1A is a view of a device according to a first embodiment

FIG. 1B shows a bottom view of a device according to a first embodiment

FIG. 2A is a view of a device according to a second embodiment

FIG. 2B is a bottom view of a device according to a second embodiment

FIG. 3A is a view of a device according to a third embodiment

FIG. 3B is a view of a device according to a third embodiment.

FIG. 4A is a view of a device according to a fourth embodiment.

FIG. 4B is a side view of a device according to a fourth embodiment.

### DETAILED DESCRIPTION

In the following detailed description the device according to the teachings for this application in the form of a miniature wireless radio frequency transmitter and receiver taillight adapter show how this wireless taillight adapter works

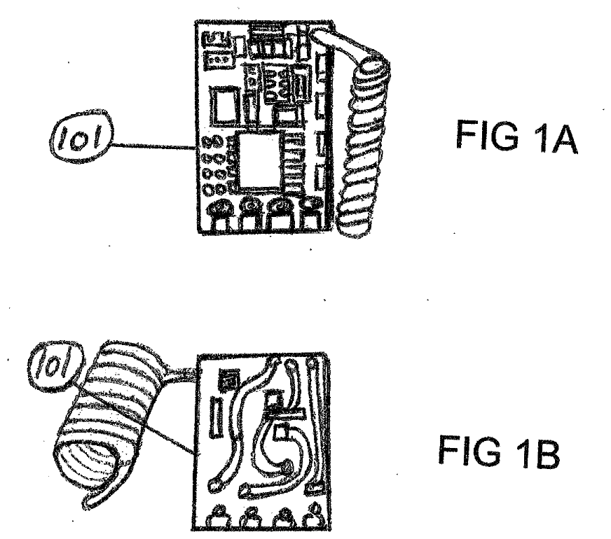

A first embodiment of the miniature 12 Volt radio frequency transmitter is illustrated in FIG. 1A and FIG. 1B FIG. 1A and FIG. 1B shows a view of a device according to the first embodiment of a miniature 12 Volt radio frequency transmitter 1.27 cm×0.794 cm×0.189 cm Sized circuit board (101) programmed at 433.92 MHz To transmit taillight signals from the automobiles taillight wiring harness to a towed trailer wirelessly an integrated miniature wireless radio frequency transmitter (101) 01 chip T×181 12 Volt 1 channel per signal line 10 d/mm TO 300 m Transmission continuous frequency coverage real time data 12 Volt power supply is from vehicles taillight wiring harness

The internal components software and programmed protocol structure of the wireless taillight towing adapter will not be described in detail such technology is generally well known

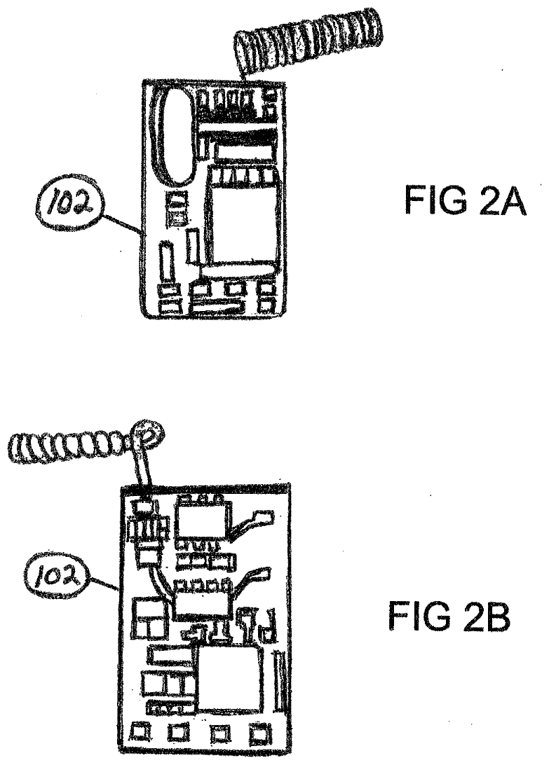

FIG. 2A and FIG. 2B show a view according to a second embodiment a 1.27 cm×0.794 cm×0.159 cm sized miniature 12 Volt wireless radio frequency receiver programmed to 433 MHz 800 W 10A 250 VAC the miniature 12 Volt radio frequency receiver captures taillight signals transmitted from The radio frequency transmitter (101) that allows real time taillight signal to be transmitted to a towed trailer for taillights wirelessly

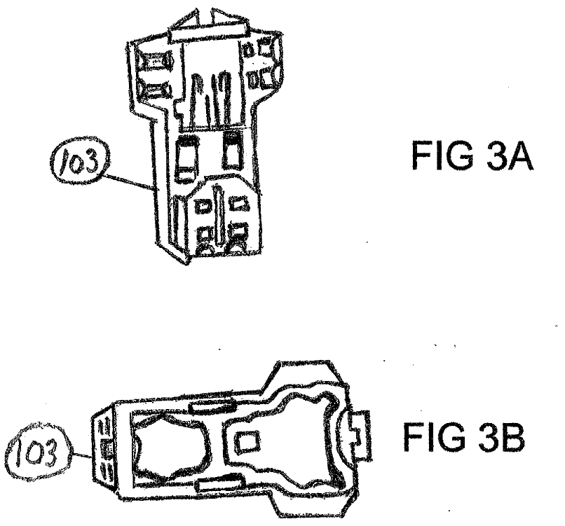

FIG. 3A and FIG. 3B Show a view of a molded plastic housing 3.175 cm×1.905 cm×1.58 cm size that contains the miniature radio frequency transmitter (101) that attaches to the vehicles taillight wiring harness to transmit taillight signals to a miniature 12 Volt radio frequency receiver (102) attached to the towed trailer for taillights wirelessly

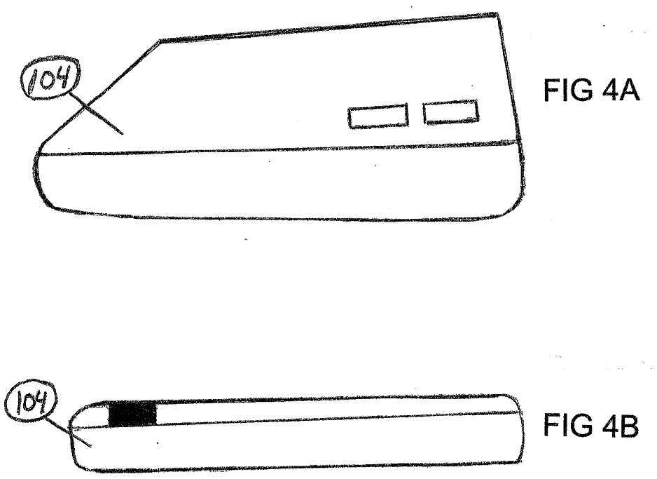

FIG. 4A and FIG. 4B show a view of a water resistant molded plastic housing 12.7 cm×7.62 cm×2.54 cm size that contains the miniature 12 Volt radio frequency receiver (102) at 433 MHz 800 W 10A 250 VAC receiver taillight signals from the miniature 12 Volt radio frequency transmitter (101) that plugs into towed trailer for taillights power supply from rechargeable 12 Volt battery pack housed inside molded plastic housing (104)

1. Wherein the wireless taillight towing adapter transmitter (101) comprising of a 1.27 cm×0.794 cm×0.189 size circuit board 433.92 MHz 10 dBM TO 3000 transmission continuous coverage program to transmit wireless taillight signals from a vehicles taillight wiring harness 2A wireless radio frequency receiver (102) attached to a towed trailer for taillights 12 Volt power supply from vehicle taillights a 3.175 cm×1905 cm×1.58 cm sized molded plastic housing (103) for housing the miniature radio frequency transmitter (101) and a 12.7 cm×7.62 cm×2.54 cm sized molded water resistant plastic housing (104) for housing the real time 433 MHz signals continuous coverage 800 W 10A 250 VAC miniature 12 Volt radio frequency receiver (102) power supply from rechargeable 12 Volt battery pack housed inside water resistant molded plastic housing (104).
